(19) United States
(12) Patent Application Publication
(10) Pub. No.: US 2021/0365813 A1
(43) Pub. Date: Nov. 25, 2021

(54) MANAGEMENT COMPUTER, MANAGEMENT PROGRAM, AND MANAGEMENT METHOD

(71) Applicant: Hitachi, Ltd., Tokyo (JP)

(72) Inventors: Kaori NAKANO, Tokyo (JP); Masaharu UKEDA, Tokyo (JP); Soichi TAKASHIGE, Tokyo (JP); Yuxin LIANG, Tokyo (JP)

(21) Appl. No.: 17/209,341

(22) Filed: Mar. 23, 2021

(30) Foreign Application Priority Data
May 21, 2020 (JP) 2020-088804

(51) Int. Cl. G06N 5/04; G06N 20/00

(52) U.S. Cl. CPC G06N 5/04; G06N 20/00

(57) ABSTRACT

A management computer for managing a system that makes an inference using a training model has a processor for performing a process in cooperation with a memory, and the processor executes: a generation process for generating an accuracy improvement prediction model for predicting the accuracy of a retrained model when retraining is executed using retraining data including new collected data collected from the system after the start of the operation of the system based on a correlation between the Feature of training data used for training of the training model and the accuracy of the training model; a prediction process for predicting the accuracy of the retrained model from the accuracy improvement prediction model and the Feature of the retraining data; and a determination process for determining whether or not the execution of the retraining is necessary based on the predicted accuracy of the retrained model.

### CROSS-REFERENCE TO RELATED APPLICATION

The present application claims priority from Japanese application JP2020-088804, filed on May 21, 2020, the contents of which is hereby incorporated by reference into this application.

### BACKGROUND

The present invention relates to a management computer, a management program, and a management method for managing an artificial intelligence (AI) system that makes an inference using a training model.

In recent years, the development of artificial intelligence for making an inference based on a training model (Machine learning model or the like) has been remarkable. For example, the accuracy of the Machine learning model is deteriorated due to changes in the environment, and thus retraining using data collected during the operation is required in some cases. For example, WO2015/152053 discloses a technique of predicting the accuracy of a Machine learning model that is currently being operated and updating the current Machine learning model with a Machine learning model after retraining based on the result of comparison with the Machine learning model after retraining in terms of accuracy.

### SUMMARY

However, in the above-described prior art, in the case where the accuracy of the Machine learning model after retraining does not satisfy the expectation due to a factor such as the insufficient number of data for retraining, unnecessary retraining is executed, and the retraining is repeated until the expected accuracy can be obtained. Therefore, there is a problem that the processing cost of the retraining is large and the retraining period cannot be estimated.

The present invention has been made in consideration of the above-described points, and the object thereof is to prevent unnecessary retraining and to reduce the processing cost of retraining of a model.

In order to solve the above-described problem, the present invention provides a management computer for managing a system that makes an inference using a training model, the computer including a processor for performing a process in cooperation with a memory, wherein the processor executes: a generation process for generating an accuracy improvement prediction model for predicting the accuracy of a retrained model when retraining is executed using retraining data including new collected data collected from the system after the start of the operation of the system based on a correlation between the Feature of training data used for training of the training model and the accuracy of the training model; a prediction process for predicting the accuracy of the retrained model from the accuracy improvement prediction model and the Feature of the retraining data; and a determination process for determining whether or not the execution of the retraining is necessary based on the predicted accuracy of the retrained model.

According to the present invention, it is possible to prevent unnecessary retraining and to reduce the processing cost of retraining of a model.

### BRIEF DESCRIPTION OF THE DRAWINGS

FIG. 1 is a diagram for showing a configuration of a management computer of a first embodiment;

FIG. 2 is a diagram for showing a correlation graph between the number of data and accuracy;

FIG. 3 is a diagram for showing a time-series graph of the accuracy of a Machine learning model in operation;

FIG. 4 is a diagram for showing a time-series graph of the number of cumulative data of a new collected data set;

FIG. 5 is a flowchart for showing an accuracy improvement prediction model generation process of the first embodiment;

FIG. 6 is a flowchart for showing a retraining accuracy prediction process of the first embodiment;

FIG. 7 is a flowchart for showing a retraining necessity determination process of the first embodiment;

FIG. 8 is a diagram for explaining a retraining period calculation process of the first embodiment;

FIG. 9 is a diagram for explaining another example of the retraining period calculation process of the first embodiment;

FIG. 10 is a diagram for showing a correlation graph between a training period and accuracy;

FIG. 11 is a diagram for showing the distribution (including new collected data) of training data;

FIG. 12 is a diagram for showing a correlation graph between the number of data for each cluster and accuracy;

FIG. 13 is a diagram for showing a situation in which the distribution of training data and the distribution of retraining data can be considered to be equivalent to each other;

FIG. 14 is a diagram for showing a correlation graph between an influence function and an accuracy difference;

FIG. 15 is a diagram for explaining target data in the retraining necessity determination process; and

FIG. 16 is a diagram for showing hardware of a computer realizing the management computer and a Machine learning model generation unit.

### DETAILED DESCRIPTION

Hereinafter, preferred embodiments of the present invention will be described. In the following, the same or similar elements and processes will be followed by the same signs to describe the differences, and the duplicated description will be omitted. In addition, in the following embodiments, differences from the already-described embodiments will be described, and the duplicated description will be omitted.

In addition, the following description and the configurations and processes shown in each drawing exemplify the outline of the embodiments to the extent necessary to understand and carry out the present invention, and are not intended to limit the mode according to the present invention. In addition, a part or all of each embodiment and each modified example can be combined within the matching range without departing from the gist of the present invention.

### (Configuration of Management Computer 1 of First Embodiment)

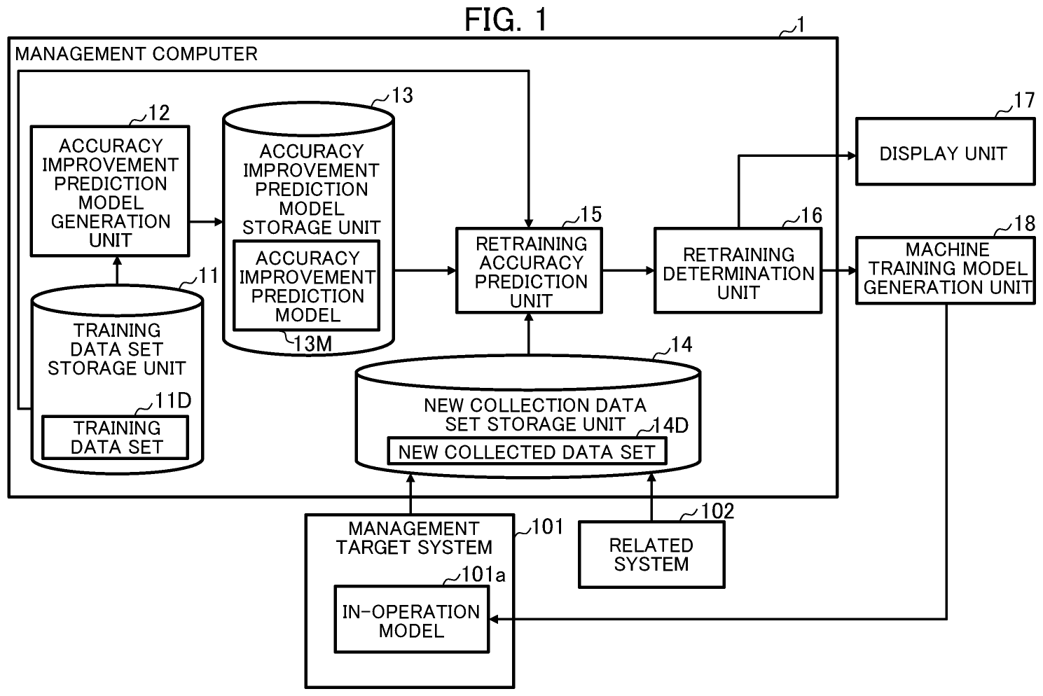

FIG. 1 is a diagram for showing a configuration of a management computer 1 of the first embodiment. The management computer 1 is a computer for managing an artificial intelligence (AI) system that makes an inference by using a training model (the embodiment is not limited to use of a Machine learning model). The management computer 1 has a training data set storage unit 11, an accuracy improvement prediction model generation unit 12, an accuracy improvement prediction model storage unit 13, a new collected data set storage unit 14, a retraining accuracy prediction unit 15, and a retraining determination unit 16. The training data set storage unit 11 stores a training data set 11D.

A display unit 17 such as a display, a Machine learning model generation unit 18, a managed system 101, and a related system 102 are connected to the management computer 1. The management target system 101 is an AI system to be managed by the management computer 1, and outputs an inference result with respect to the input Feature by using an in-operation model 101a that is a Machine learning model being operated by the management target system 101 in operation. The related system 102 acquires validation data (measured data) corresponding to the inference result (prediction data) of the management target system 101 from the actual operation and outputs the same.

The training data set storage unit 11 stores the training data set 11D used for training of the in-operation model 101a.

The accuracy improvement prediction model generation unit 12 trains in advance a correlation between the Feature (the number of data is used in the embodiment, but the present invention is not limited to this) of the training data set 11D stored in the training data set storage unit 11 and the accuracy of model (hereinafter, referred to as “accuracy”) of the in-operation model 101a, and generates an accuracy improvement prediction model 13M. The accuracy of the in-operation model 101a is an accuracy index calculated based on the prediction data and the measured data, and includes the correct answer rate of the prediction data and an error of the prediction data with respect to the measured data.

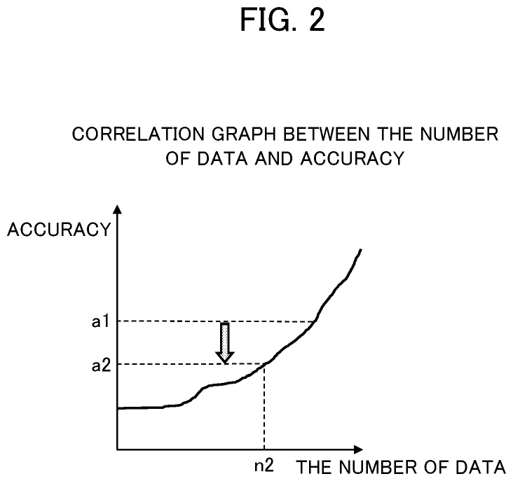

That is, the accuracy improvement prediction model generation unit 12 creates a data set in which the number of data in the training data set 11D is used as an explanatory variable and the accuracy of the in-operation model 101a is used as an objective variable. Then, the accuracy improvement prediction model generation unit 12 trains the created data set and generates the accuracy improvement prediction model 13M obtained by modeling the correlation between the number of data and the accuracy. The accuracy improvement prediction model generation unit 12 stores the generated accuracy improvement prediction model 13M in the accuracy improvement prediction model storage unit 13. The accuracy improvement prediction model 13M is represented by, for example, a correlation graph shown in FIG. 2. FIG. 2 is a diagram for showing the correlation graph between the number of data and the accuracy.

Note that when the accuracy improvement prediction model generation unit 12 trains the accuracy improvement prediction model 13M, a data set including data collected from other systems making an inference using a training model in addition to the training data set 11D may be used. Accordingly, the accuracy of the accuracy improvement prediction model 13M can be improved.

Note that the generation of the accuracy improvement prediction model 13M is not limited to the training data set 11D of the in-operation model 101a, and the training data set of a model used in the past operation may be used.

The accuracy improvement prediction model 13M is a model for predicting the accuracy of the in-operation model 101a generated when retraining is performed using retraining data including at least a new collected data set 14D collected from the management target system 101 and the related system 102.

Here, the new collected data set 14D is a data set that is acquired after the start of the operation of the in-operation model 101a and includes the input Feature used for inference in the management target system 101, the inference result, and validation data acquired in the actual operation in the related system 102.

The retraining accuracy prediction unit 15 monitors the number of data in the new collected data set 14D collected from the management target system 101 in operation. Then, based on the number of data in the retraining data set and the accuracy improvement prediction model 13M, the retraining accuracy prediction unit 15 predicts the accuracy of the Machine learning model (hereinafter, referred to as “retrained model”) when retraining is performed using the retraining data set.

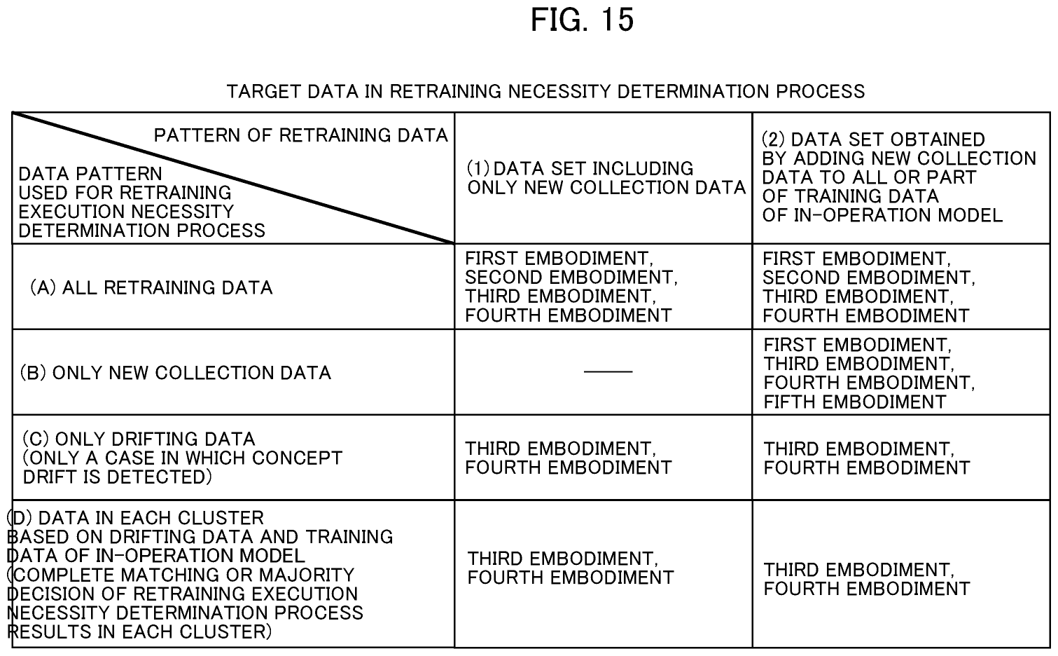

Here, as shown in FIG. 15, the pattern of the retraining data used for the retraining is (1) a data set including only the new collected data set 14D, or (2) a data set obtained by adding the new collected data set 14D to all or a part of the training data set 11D of the in-operation model 101a in the embodiment. Details of FIG. 15 will be described later.

The retraining determination unit 16 calculates a “reference value” based on the accuracy of the in-operation model 101a. The retraining determination unit 16 performs a retraining necessity determination process that determines that the retraining is executed if the accuracy of the retrained model predicted by the retraining accuracy prediction unit 15 exceeds the “reference value” and the retraining is not executed if the accuracy does not exceed the “reference value”. In the example of FIG. 2, since the “reference value” is the accuracy a1 of the current in-operation model 101a and the accuracy a2 when the number of data in the current new collected data set is n2 is less than the accuracy a1, it is determined that the retraining is not executed. [0023]

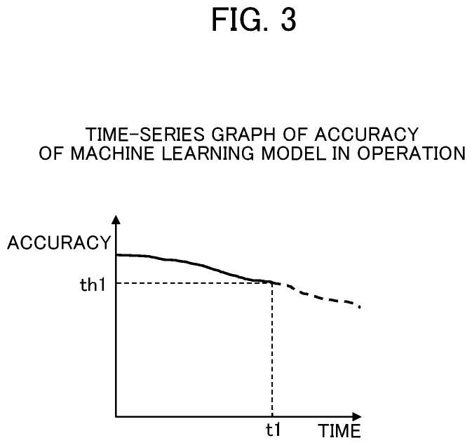

In the embodiment, the “reference value” is the current accuracy of the in-operation model 101a. The accuracy of the in-operation model 101a is monitored by, for example, the retraining accuracy prediction unit 15, and a time-series transition is recorded. FIG. 3 is a diagram for showing a time-series graph of the accuracy of the in-operation model 101a in operation.

However, the “reference value” is not limited to the current accuracy of the in-operation model 101a, and may be a value higher (or lower) than the current accuracy of the in-operation model 101a by a predetermined value, or the accuracy at the time of starting the operation of the in-operation model 101a. Alternatively, the “reference value” may be the accuracy of a predetermined period ahead that can be predicted by the in-operation model 101a (see the prior art document (WO2015/152053)).

Here, data to be used in the retraining necessity determination process of the first embodiment will be described with reference to FIG. 15. FIG. 15 is a diagram for explaining target data in the retraining necessity determination process, and is a table for showing which embodiment (the first embodiment and second to fifth embodiments to be described later) a combination of the data pattern used in the retraining necessity determination process and the pattern of the retraining data can be applied to.

As shown in FIG. 15, the pattern of the retraining data used for the retraining is (1) a data set including only the new collected data set 14D, or (2) a data set obtained by adding the new collected data set 14D to all or a part of the training data set 11D of the in-operation model 101a in the embodiment. In addition, as shown in FIG. 15, the data pattern used for the retraining necessity determination process is (A) all the retraining data, or (B) the new collected data set 14D added in the retraining data set in the embodiment.

That is, combinations of the data pattern used for the retraining necessity determination process and the pattern of the retraining data correspond to three combinations of (A) and (1), (A) and (2), and (B) and (2) in FIG. 15 in the embodiment.

Note that in the case where (2) a data set obtained by adding the new collected data to all or a part of the training data of the in-operation model 101a is used as the retraining data set used for the retraining, a three-dimensional correlation graph among “the number of original data”, “the number of additional data”, and “accuracy” is used instead of the correlation graph between the number of data and the accuracy shown in FIG. 2. “All or a part of the in-operation model 101a” is “the number of original data”, and the number of “new collected data” is “the number of additional data”.

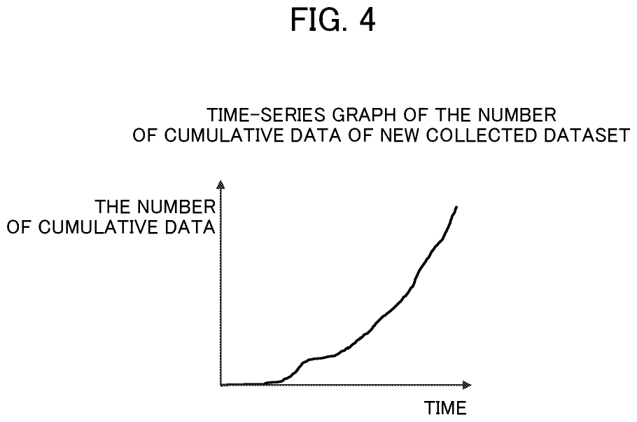

The explanation of FIG. 1 will be made again. The retraining determination unit 16 allows the display unit 17 to display the determination result of whether or not the execution of the retraining is necessary (“possible to execute the retraining” or “impossible to execute the retraining”). In addition, the retraining determination unit 16 allows the display unit 17 to display at least one of the correlation graph (FIG. 2) between the number of data and the accuracy, the time-series graph (FIG. 3) of the accuracy of the in-operation model 101a, the time-series graph (FIG. 4) of the number of cumulative data of the new collected data set, and the value of the accuracy of the retrained model predicted by the retraining accuracy prediction unit 15. The number of data (cumulative value) is the number of data in the new collected data set acquired from the management target system 101 after the start of the operation.

In addition, in the case where it is determined that the accuracy at the time of retraining predicted by the retraining accuracy prediction unit 15 reaches the “reference value”, the retraining determination unit 16 outputs an execution instruction to perform the retraining to the Machine learning model generation unit 18 using the retraining data set. The Machine learning model generation unit 18 automatically executes the retraining by using the retraining data set in accordance with the execution instruction of the retraining.

Here, as shown in FIG. 3, the timing when the retraining determination unit 16 determines whether or not the execution of the retraining is necessary is time t1 at which it can be determined that the accuracy of the in-operation model 101a in operation exceeds a threshold value th1 and the accuracy is deteriorated. However, the present invention is not limited to this, and the retraining determination unit 16 may periodically determine whether or not the accuracy at the time of retraining exceeds the “reference value” to execute the retraining when the accuracy exceeds the “reference value”.

### (Accuracy Improvement Prediction Model Generation Process of the First Embodiment)

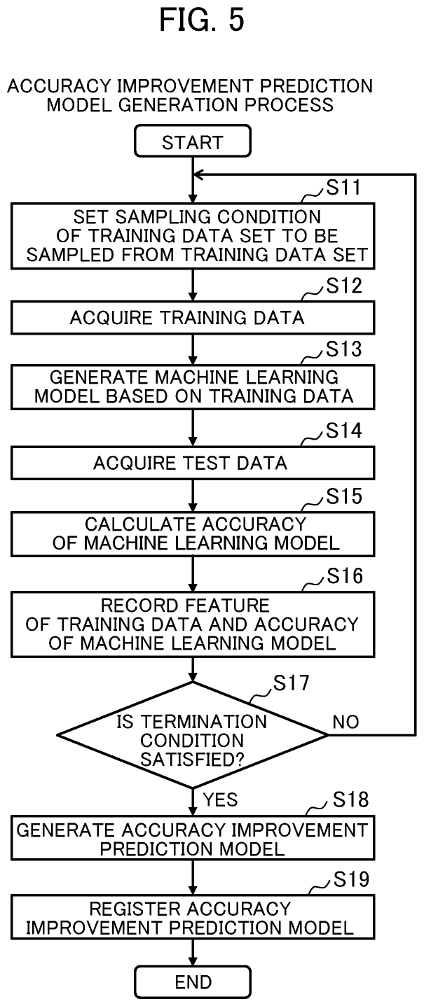

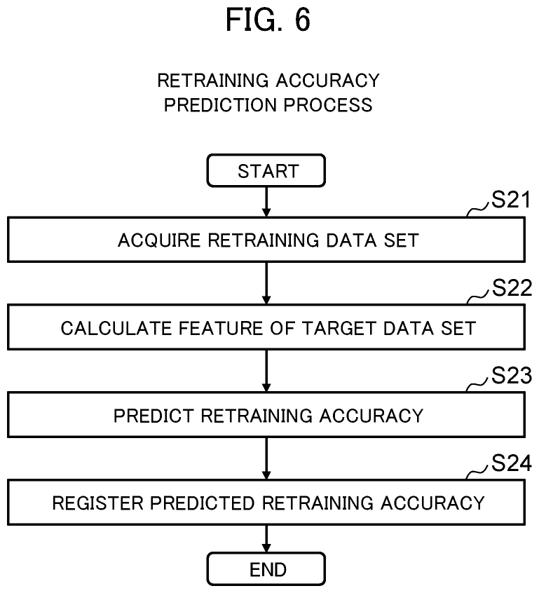

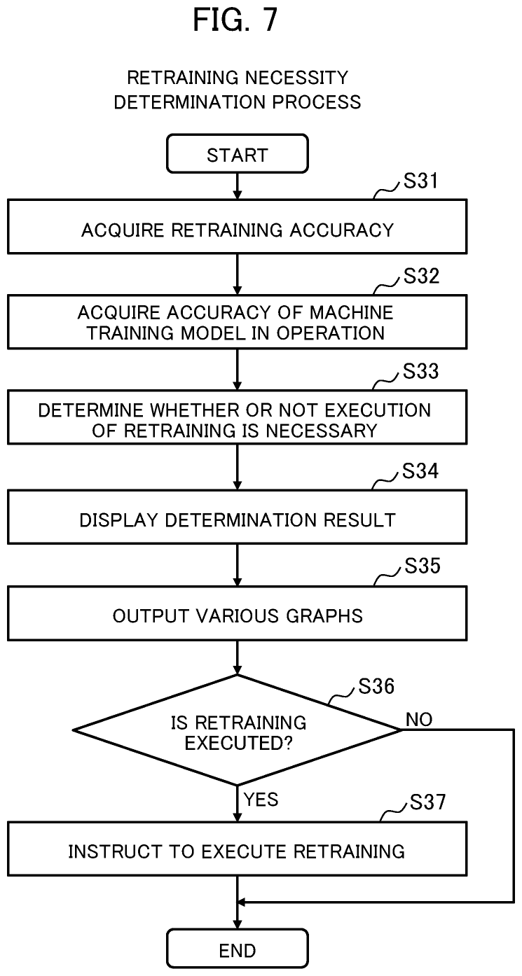

FIG. 5 is a flowchart for showing an accuracy improvement prediction model generation process of the first embodiment. The accuracy improvement prediction model generation process is preliminarily executed prior to a retraining accuracy prediction process (FIG. 6) and a retraining determination process (FIG. 7) to be described later.

First, in Step S11, the accuracy improvement prediction model generation unit 12 sets a sampling condition (the number of data to be sampled in the embodiment) of a training data set to be sampled from the training data set 11D. Next, in Step S12, the accuracy improvement prediction model generation unit 12 acquires the training data set from the training data set 11D according to the sampling condition set in Step S11. Next, in Step S13, the accuracy improvement prediction model generation unit 12 generates a Machine learning model based on the training data acquired in Step S12.

Next, in Step S14, the accuracy improvement prediction model generation unit 12 acquires test data from the training data set. Next, in Step S15, the accuracy improvement prediction model generation unit 12 calculates the accuracy of the Machine learning model generated in Step S13 using the test data.

Next, in Step S16, the accuracy improvement prediction model generation unit 12 records a set of the Feature of the training data set acquired in Step S12 and the accuracy of the Machine learning model calculated in Step S15.

Next, in Step S17, the accuracy improvement prediction model generation unit 12 determines whether or not a termination condition is satisfied. The termination condition is, for example, to generate the Machine learning model by sufficiently covering the pattern of the number of data and to record the accuracy corresponding to each number of data. The accuracy improvement prediction model generation unit 12 moves the process to Step S18 when the termination condition is satisfied (Yes in Step S17), and returns the process to Step S11 when the termination condition is not satisfied (No in Step S17). In Step S11 to which the process is returned from Step S17, the number of new data of the training data set sampled in Step S12 is set.

In Step S18, the accuracy improvement prediction model generation unit 12 generates an accuracy improvement prediction model 13M from the set of the number of data of the training data set and the accuracy of the Machine learning model recorded in Step S16. Next, in Step S19, the accuracy improvement prediction model generation unit 12 registers the accuracy improvement prediction model generated in Step S18 in the accuracy improvement prediction model storage unit 13.

### (Retraining Accuracy Prediction Process of the First Embodiment)

FIG. 6 is a flowchart for showing the retraining accuracy prediction process of the first embodiment. First, in Step S21, the retraining accuracy prediction unit 15 acquires the retraining data set including the new collected data set 14D. Next, in Step S22, the retraining accuracy prediction unit 15 calculates the Feature (the number of data) of the retraining data set acquired in Step S21.

Next, in Step S23, the retraining accuracy prediction unit 15 predicts the accuracy (retraining accuracy) of the Machine learning model when the retraining is performed using the retraining data set based on the accuracy improvement prediction model 13M and the number of data in the retraining data set. Next, in Step S24, the retraining accuracy prediction unit 15 registers the predicted retraining accuracy in a predetermined storage area.

### (Retraining Necessity Determination Process of the First Embodiment)

FIG. 7 is a flowchart for showing the retraining necessity determination process of the first embodiment. First, in Step S31, the retraining determination unit 16 acquires the retraining accuracy registered in Step S24 of the retraining accuracy prediction process. Next, in Step S32, the retraining determination unit 16 acquires the accuracy of the in-operation model 101a. Next, in Step S33, the retraining determination unit 16 determines whether or not the execution of the retraining is necessary.

Next, in Step S34, the retraining determination unit 16 allows the display unit 17 to display the determination result (“possible to execute the retraining” or “impossible to execute the retraining”) of Step S33. At this time, the value of the accuracy of the retrained model predicted in Step S23 may be also displayed. Next, in Step S35, the retraining determination unit 16 allows the display unit 17 to display various graphs of the correlation graph (FIG. 2) between the number of data and the accuracy, the time-series graph (FIG. 3) of the accuracy of the in-operation model 101a, and the time-series graph (FIG. 4) of the number of cumulative data of the new collected data set 14D.

In the case where the determination result in Step S33 is “possible to execute the retraining” (Yes in Step S36), the retraining determination unit 16 outputs a retraining execution instruction to the Machine learning model generation unit 18. On the other hand, in the case where the determination result in Step S33 is “impossible to execute the retraining” (No in Step S36), the retraining determination unit 16 does not output the retraining execution instruction and terminates the retraining necessity determination process.

According to the embodiment, unnecessary retraining of the Machine learning model can be reduced, and the cost of the retraining can be reduced.

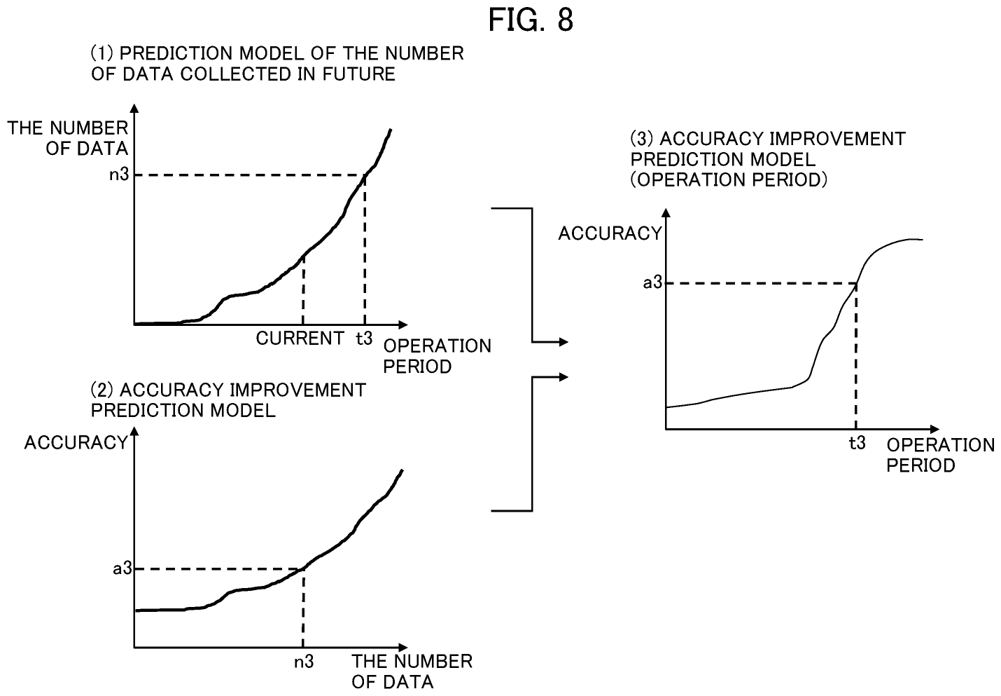

Note that in the case where it is determined that the retraining cannot be executed because the retraining accuracy is not sufficient in the retraining necessity determination, the retraining determination unit 16 calculates an appropriate future retraining period in which the retraining can be executed as follows. FIG. 8 is a diagram for explaining a retraining period calculation process of the first embodiment.

As shown in FIG. 8, a prediction model of the number of data collected in the future to predict the number of new collected data to be collected in the future is first created from the collection rate (the number of collections per unit time) of the collected training data. Next, the accuracy of the retrained model in the future is predicted from the prediction model of the number of data collected in the future and the accuracy improvement prediction model. Next, an appropriate future retraining period is calculated from an operation period t3 corresponding to the number of data n3 in which the accuracy of the retrained model is predicted to exceed a reference value a3, and is proposed by displaying the same on the display unit 17.

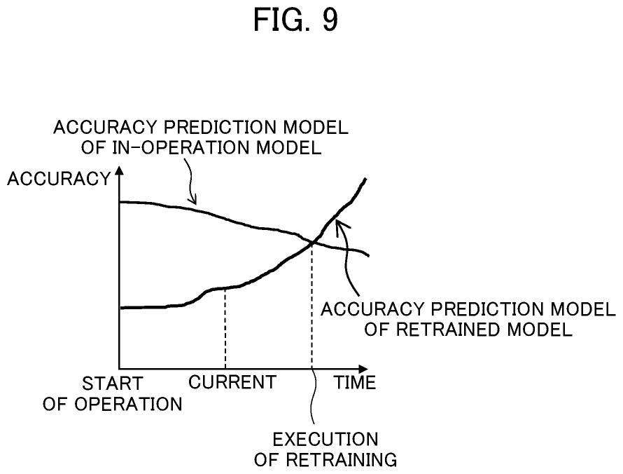

In addition, in the case where it is determined that the retraining cannot be executed because the retraining accuracy is not sufficient in the retraining necessity determination, the retraining determination unit 16 may calculate the appropriate future retraining period in which the retraining can be executed as follows. FIG. 9 is a diagram for explaining another example of the retraining period calculation process of the first embodiment.

As shown in FIG. 9, the future accuracy of the in-operation model 101a is predicted based on the accuracy prediction model (created by using the prior art) of the in-operation model 101a, the future accuracy of the retrained model is predicted from the prediction model of the number of data collected in the future and the accuracy improvement prediction model as similar to FIG. 8 (FIG. 8 (3)), and the date and time when the future accuracy of the retrained model exceeds the future accuracy of the in-operation model 101a is proposed as a retraining execution date and time by displaying the same on the display unit 17. Alternatively, the date and time when exceeding the reference value (for example, the accuracy of the in-operation model 101a at the start of the operation) may be proposed as the retraining execution date and time.

Accordingly, the timing to perform the retraining can be recognized, useless retraining can be suppressed, and the cost of the retraining can be reduced.

### Second Embodiment

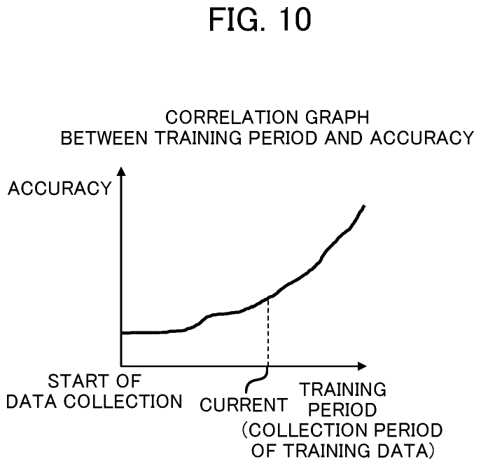

In the first embodiment, the accuracy improvement prediction model 13M is generated based on the number and accuracy of the training data set 11D, and the the retraining necessity determination is performed based on the accuracy improvement prediction model 13M and the retraining data set. On the other hand, it is assumed in the second embodiment that the number of data of the first embodiment is replaced by the training period as the Feature, and the correlation graph (FIG. 2) between the number of data and the accuracy is replaced by the correlation between the training period (collection period of the training data) and the accuracy shown in FIG. 10. FIG. 10 is a diagram for showing the correlation graph between the training period and the accuracy. The others are the same as those of the first embodiment.

The number of data in the new collected data set 14D increases in accordance with the passage of the training period (operation period of the management target system 101), and the data distribution range is expanded to improve the accuracy. Therefore, even if the number of data is replaced by the training period in the embodiment, the accuracy improvement prediction model can be generated from the accuracy improvement prediction model and the training period as similar to the first embodiment, and the retraining accuracy can be estimated.

Note that the training period (operation period) on the time axis is used as an alternative index of the number of data in the embodiment. Therefore, when the collection rate per unit time of the new collected data set 14D changes from the collection rate per unit time of the training data set 11D at the time of generating the accuracy improvement prediction model, the preconditions of the accuracy at the time of generating the accuracy improvement prediction model and the accuracy at the time of calculating the retraining accuracy do not match each other, and the accuracy of the accuracy improvement prediction model 13M is deteriorated.

Accordingly, the collection rate per unit time of the new collected data set 14D is compared with the collection rate per unit time of the training data set 11D at the time of generating the accuracy improvement prediction model, and the accuracy improvement prediction model may be modified so as to absorb a change in the collection rate in accordance with the degree of the change in the collection rate. For example, the correlation graph of the accuracy improvement prediction model is modified in accordance with the difference or ratio of the collection rate. Accordingly, the deterioration of the accuracy of the accuracy improvement prediction model 13M can be corrected.

In the embodiment, the data pattern used for the retraining necessity determination process is only (A) all the retraining data shown in FIG. 15. Thus, combinations of the data pattern used for the retraining necessity determination process and the pattern of the retraining data correspond to two combinations of (A) and (1) and (A) and (2) in FIG. 15.

Note that even in the embodiment, in the case where it is determined that the retraining cannot be executed because the retraining accuracy is not sufficient in the retraining necessity determination, the accuracy of the future retrained model can be predicted based on the accuracy improvement prediction model 13M (FIG. 10) of the retrained model starting from the data collection start point, and the appropriate future retraining period in which the retraining can be executed can be calculated.

### Third Embodiment

In the third embodiment, the training data set 11D is grouped (for example, clustered) based on the Feature, and each accuracy improvement prediction model 13M is generated based on the correlation between the Feature and the accuracy of the data set of each group. In addition, the retraining data set is grouped based on the Feature, and the retraining necessity determination is performed based on the accuracy improvement prediction model 13M of each cluster and an existing group obtained by grouping a new group and the training data set 11D. The others are the same as those of the first embodiment. Hereinafter, the grouping will be described with clustering as an example. In addition, it is assumed that the Feature of the data set for obtaining the correlation with the accuracy is the number of data.

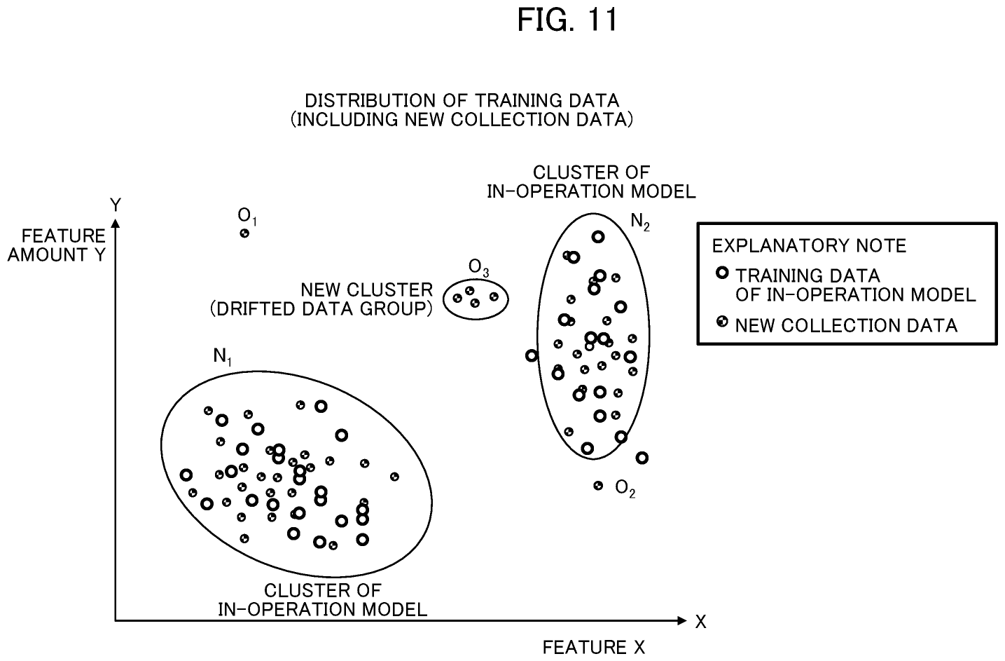

For example, it is assumed that the training data set and the new collected data set of the in-operation model 101a in operation (or in the past) are clustered based on a Feature X and a Feature Y, and the distribution shown in FIG. 11 is obtained. FIG. 11 is a diagram for showing the distribution (including new collected data) of the training data.

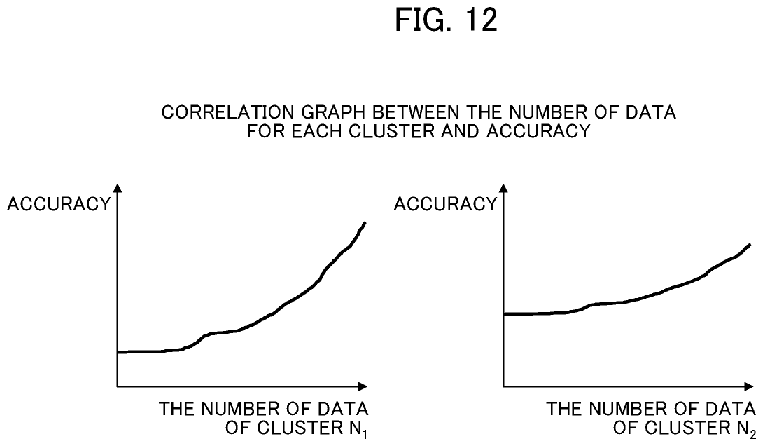

Hereinafter, a case in which the clusters shown in FIG. was obtained will be described. The clusters of the training data set of the in-operation model 101a are clusters N₁ and N₂, and there are new collected data belonging to the clusters N₁ and N₂ while there are new clusters O₁, O₂, and O₃ including only new collected data. Then, as shown in FIG. 12, the correlation between the number of data and the accuracy is calculated for each of the clusters N₁ and N₂.

The correlation between the number of data and the accuracy for each cluster in the embodiment is caluculated by one of the following two methods. First, the accuracy improvement prediction model generation unit 12 randomly increases the number of data in the training data set 11D, and calculates the correlation between the number of data and the accuracy for each of the clusters N₁ and N₂. Second, the accuracy improvement prediction model generation unit 12 calculates the correlation between the number of data and the accuracy for each of the clusters N₁ and N₂ by setting a specific cluster (for example, the cluster N₁) as a cluster in which the number of data is increased and the other cluster (for example, the cluster N₂) as a cluster in which the number of data is constant.

Note that the generation of the accuracy improvement prediction model 13M is not limited to the training data set 11D of the in-operation model 101a, and the training data set of a model used in the past operation may be used.

In this way, as shown in FIG. 12, plural correlations between the number of data and the accuracy for each cluster are obtained. The accuracy improvement prediction model generation unit 12 uses any one of the plural correlations between the number of data and the accuracy for each cluster or the average of the plural correlations between the number of data and the accuracy for each cluster as the accuracy improvement prediction model 13M.

In the embodiment, the data patterns used for the retraining necessity determination process are (A) all the retraining data, (B) new collected data, (C) only the drifting data, and (D) clusters of the drifting data and the in-operation model 101a shown in FIG. 15. Combinations of the data pattern and the retraining data pattern used in the retraining necessity determination process are shown in FIG. 15.

Here, in (C), the retraining determination unit 16 determines whether or not the execution of the retraining is necessary based on the accuracy of the retrained model predicted based on the accuracy improvement prediction model 13M of each cluster and the number of data belonging to the new cluster O₃ drifting from the clusters N₁ and N₂ of the in-operation model 101a.

In addition, the retraining necessity determination may be executed as follows. That is, when the number of data belonging to the new cluster O₃ drifting from the clusters N₁ and N₂ of the in-operation model 101a or the number of data within the standard deviation from the center of the new cluster O₃ can be regarded as the same as the clusters of the in-operation model 101a, the retraining determination unit 16 determines that the retraining is executed using the retraining data set.

In addition, in (D), the retraining determination unit 16 determines whether or not the execution of the retraining is necessary for each cluster based on the accuracy of the retrained model predicted based on the accuracy improvement prediction model 13M of each cluster and either or both of the number of data in the cluster (new cluster) of the drifting data as a result of clustering the retraining data and the number of data in the cluster (existing cluster) of the in-operation model 101a. The retraining determination unit 16 determines whether or not the final execution of the retraining is necessary by the complete matching or majority decision of the plural determination results.

### Fourth Embodiment

In the fourth embodiment, the following determination process is added to the retraining necessity determination of the first embodiment. That is, in the case where the retraining accuracy based on the number of data reaches the reference value and the probability distribution (hereinafter, referred to as “distribution”) of the retraining data is considered to be equivalent to the distribution of the training data of the in-operation model 101a for a certain Feature, the retraining determination unit 16 determines that sufficient training data can be collected and the retraining can be executed. The Feature for comparing the distribution may be one or more.

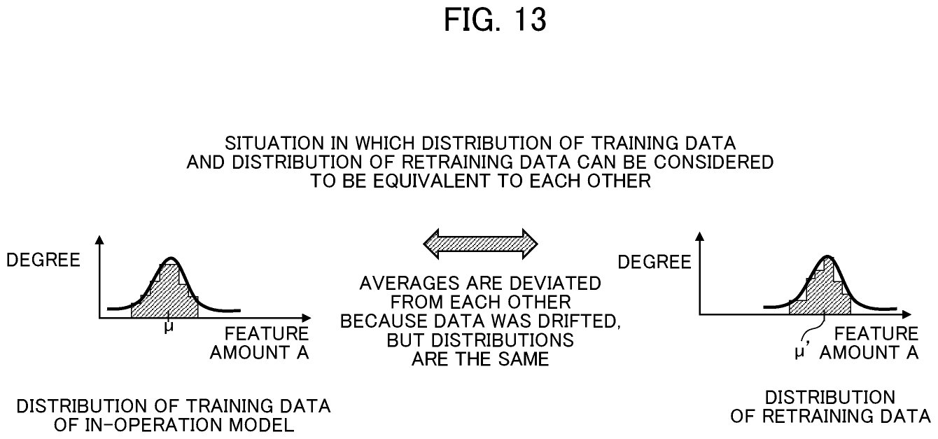

FIG. 13 is a diagram for showing an outline in which the distribution of the training data and the distribution of the retraining data can be considered to be equivalent to each other. As shown in FIG. 13, although the distribution of the training data of the in-operation model 101a having an average μ and the distribution of the retraining data having an average μ′ for a Feature A are different from each other in average due to the drift of the data, both distributions can be considered to be equivalent to each other when the index values characterizing the distributions are the same.

The Features to be compared for the distribution may be all the Features of the training data and the retraining data, or the top n Features affecting the inference result of the in-operation model 101a derived by the explainable AI.

In the determination of whether or not the distributions are equivalent to each other, if the difference, ratio, or distance between the predetermined statistical indices of the distributions of the training data and the retraining data is equal to or smaller than a certain value, both distributions are considered to be equivalent to each other. The difference, ratio, or distance is a Feature representing a relationship between the predetermined statistical indices of the training data and the retraining data. The predetermined statistical index in this case is one or more of skewness, kurtosis, standard deviation, and variance. The data may be normalized (standardized) to compare the distributions.

Alternatively, in the determination of whether or not the distributions are equivalent to each other, the training data and the retraining data of the in-operation model 101a are normalized (standardized), and both distributions may be considered to be equivalent to each other if the similarity (for example, KL divergence) is equal to or larger than a certain value.

Note that a correlation graph of the difference (or percentage) of the skewness, kurtosis, standard deviation, and variance and the accuracy, or a correlation graph of the similarity and the accuracy may be created to predict the retraining accuracy. In this case, it is assumed that the number of data at the time of creating the correlation graph is uniform. In addition, the execution of the retraining accuracy prediction process may be limited only when the number of retraining data is within a predetermined range. For example, the retraining accuracy prediction process may be executed only when the number of retraining data is within a predetermined range with respect to the number of data at the time of creating the correlation graph used for the retraining accuracy prediction process. Whether or not the execution of the retraining is necessary may be determined based on whether or not the accuracy predicted based on the correlation graph of the predetermined statistical index and the accuracy and the retraining data has reached the reference value.

In the final determination of whether or not the execution of the retraining is necessary, in the case where all of the retraining necessity determination results based on the number of data and the retraining necessity determination results based on the comparison of the distributions of the Feature are possible to execute the retraining, it is determined that the retraining can be executed.

Alternatively, in the final determination of whether or not the execution of the retraining is necessary, the necessity is determined by a majority decision among the retraining necessity determination results based on the number of data and the retraining necessity determination results based on the comparison of the distributions of the Feature. In the majority decision, in the case where the number of determinations of possible to execute the retraining is equal to that of determinations of impossible to execute the retraining, the retraining necessity determination result based on the number of data is given priority.

Alternatively, in the final determination of whether or not the execution of the retraining is necessary, the necessity may be determined using only the retraining necessity determination result based on the comparison of the distributions of the Feature without using the retraining necessity determination result based on the number of data. In this case, in the case where all of the retraining necessity determination results based on the comparison of the distributions of the Feature are possible to execute the retraining, it may be determined that the retraining can be executed, or the necessity may be determined by a majority decision.

In the embodiment, the data patterns used for the retraining necessity determination process are the same as those of the third embodiment as shown in FIG. 15. However, in the cases (C) and (D) of FIG. 15, in the case where the distribution of the Feature A of the retraining data is changed with respect to the distribution of the Feature A of the in-operation model 101a, it is determined whether a new cluster has occurred or whether a cluster has moved. Then, in the case where a new cluster (or a moving cluster) has occurred, the data belonging to the new cluster (moving cluster) and the data belonging to the cluster before the change of the distribution are separated from each other, and the distribution of the data of each cluster after the separation is compared with the distribution of the training data of the in-operation model 101a.

### Fifth Embodiment

In the case where the Machine learning model is retrained using the retraining data including the new collected data set 14D, an internal parameter θ configuring the model may be largely affected. In the fifth embodiment, in the case where the internal parameter θ largely changes, it is considered that the accuracy of the in-operation model 101a is largely affected, and whether or not the execution of the retraining is necessary is determined.

For the in-operation model 101a, the influence function (Influence Function) Δθ is derived (Reference: Pang Wei Koh, Percy Liang, “Understanding Black-box Predictions via Influence Functions”, Jul. 10, 2017, URL: https://arxiv.org/pdf/1703.04730.pdf) . In the embodiment, the influence function of data is used as the Feature of data.

The influence function A0z described in the following equation (1) is the difference between the internal parameter θ_{-z} of the model trained by excluding the training data Z from the training data set and the internal parameter θ of the in-operation model 101a. In the reference, the influence function is derived without training, but may be derived while actually training.

Δθ_{Z}=θ_{-z}−θ=I_{up.param}(Z) (1)

In the above equation (1), Z is the training data at the time of generating the in-operation model 101a, and θ is the internal parameter configuring the in-operation model 101a.

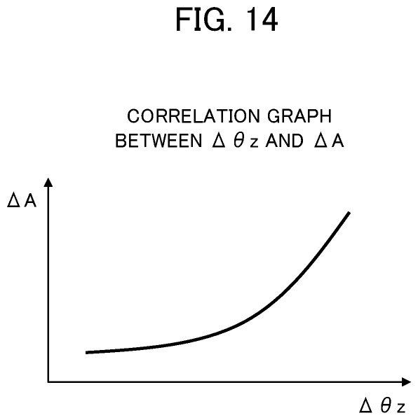

The accuracy improvement prediction model generation unit 12 creates a correlation graph of Δθ and ΔA by creating a model and calculating Δθ and ΔA while changing the training data Z with respect to the accuracy difference ΔA between the accuracy of the in-operation model 101a and the accuracy of the model when the training data Z is excluded from the training data set 11D of the in-operation model 101a. The accuracy improvement prediction model 13M thus created is as shown in FIG. 14. FIG. 14 is a diagram for showing a correlation graph between the influence function and the accuracy difference.

The retraining accuracy prediction unit 15 calculates Δθ_{z′i} of each data z′ᵢ of a new collected data set Z′ from the influence function, and obtains the corresponding Δθ_{z′i} from the accuracy improvement prediction model 13M as shown in FIG. 14. Here, it is assumed that the influence function of the accuracy of the retrained model by the new collected data set correlates with the influence function of the in-operation model 101a of the above equation (1).

If the sum or average of plural ΔA_{z′i} obtained by the retraining accuracy prediction unit 15 is equal to or larger than a certain value, the retraining determination unit 16 considers that the effect of the new collected data set Z′ on the accuracy of the in-operation model 101a is large, and determines that the retraining can be executed.

### Other Embodiments

In addition to the first to fifth embodiments described above, embodiments that can be carried out are shown.

### (1) Recommendation to Expand Retraining Data

In the case where it is determined that the retraining cannot be executed because the retraining accuracy is not sufficient in the retraining necessity determination, the retraining determination unit 16 recommends to expand the retraining data by displaying on the display unit 17. Methods for expanding the retraining data include diverting the training data of the in-operation model 101a, performing data augmentation (padding) of the retraining data, and actively acquiring data so as to correct the deviation of the retraining data (for example, replenishing data in a period that is smaller in the number of data than other periods). The retraining data is expanded in accordance with the recommendation, so that the retraining accuracy can be improved.

### (2) Creating Accuracy Improvement Prediction Model

In the above-described embodiments, one accuracy improvement prediction model 13M is created for one management target system (Machine learning model). However, the present invention is not limited to this, and one accuracy improvement prediction model may be generated for plural management target systems having common features. That is, the accuracy improvement prediction model 13M is generated for each Feature characterizing the system for making an inference by using the training model.

When predicting the retraining accuracy, one is selected from plural accuracy improvement prediction models according to the features of the management target system to be predicted. The features of the management target system include the algorithm of the artificial intelligence, the type of Feature (for example, time-series data or the like), and the kind of problem solved by the artificial intelligence system (prediction or determination). In addition, the accuracy improvement prediction model may be selected using the closeness of the model as a reference based on the internal parameter. Accordingly, the accuracy of the accuracy improvement prediction model 13M can be improved.

### (3) Update of Accuracy Improvement Prediction Model

Every time the in-operation model 101a is updated with the retrained model, the accuracy improvement prediction model 13M may be updated. Accordingly, the accuracy of the accuracy improvement prediction model 13M can be improved.

### (4) Method for Generating Accuracy Improvement Prediction Model

When a correlation graph of accuracy with respect to the value of the Feature of a data set is created, a method for determining the Feature (the number of data, a data training period, the number of data in a cluster, data skewness, kurtosis, standard deviation, and variance, or the like) of the data set, and a data set for training for creating the accuracy improvement prediction model is as follows. Note that it is assumed that the data set for training and the data set for evaluation are separated from each other in advance by a general method.

The value of the Feature of the data set and the sampling of the training data set are randomly determined to perform training (which can be applied to any of the embodiments). Alternatively, the training data set is previously clustered, and the accuracy improvement prediction model 13M is generated based on the correlation between the Feature of the training data obtained by sampling the same number of data from each cluster and the accuracy of the training model when the training data is used for training (which can however be applied to only the first, third, and fourth embodiments).

In addition, when the correlation graph between the data Feature and the accuracy is generated, the value of the Feature to be sampled is sampled by using a Bayesian optimization method such as TPE (Tree Parzen Estimator). In addition, as the method for generating the correlation graph between the data Feature and the accuracy, a general regression analysis or other machine training algorithms may be used.

### (Computer Hardware)

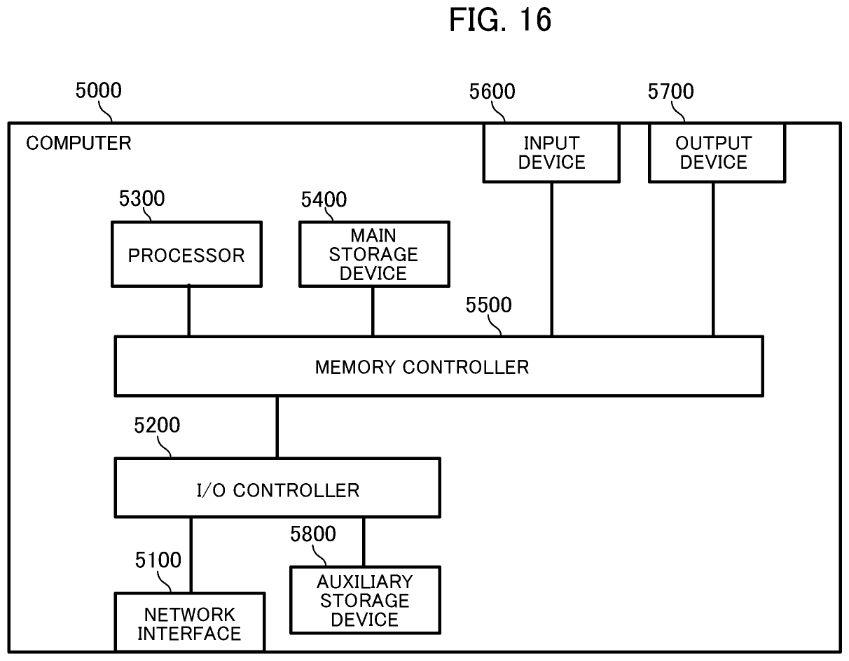

FIG. 16 is a diagram for showing hardware of a computer realizing the management computer 1 and the Machine learning model generation unit 18. In a computer 5000 realizing the management computer 1 and the Machine learning model generation unit 18, a processor 5300 represented by a CPU (Central Processing Unit), a main storage device (memory) 5400 such as a RAM (Random Access Memory), an input device 5600 (for example, a keyboard, a mouse, a touch panel, and the like), and an output device 5700 (for example, a video graphic card connected to an external display monitor) are connected to each other through a memory controller 5500.

The processor 5300 executes a program in cooperation with the main storage device 5400 to realize the accuracy improvement prediction model generation unit 12, the retraining accuracy prediction unit 15, and the retraining determination unit 16.

In the computer 5000, programs for realizing the management computer 1 and the Machine learning model generation unit 18 are read through an I/O (Input/Output) controller 5200 from an external storage device 5800 such as an SSD or HDD, and are executed in cooperation with the processor 5300 and the main storage device 5400 to realize the management computer 1 and the Machine learning model generation unit 18.

Alternatively, each program for realizing the management computer 1 and the Machine learning model generation unit 18 may be stored in a computer readable medium and read by a reading device, or may be acquired from an external computer by communications through the network interface 5100.

In addition, the management computer 1 and the Machine learning model generation unit 18 may be configured using one computer 5000. Alternatively, the management computer 1 may be configured in such a manner that each part is distributed and arranged in plural computers, and distribution and integration are arbitrary depending on the processing efficiency and the like.

In addition, information displayed by the display unit may be displayed on the output device 5700, or may be notified to an external computer by communications through the network interface 5100 to be displayed on an output device of the external computer.

Note that the present invention is not limited to the above-described embodiments, but includes various modified examples. For example, the above-described embodiments have been described in detail to easily understand the present invention, and the present invention is not necessarily limited to those including all the configurations described above. In addition, insofar as it is not incompatible, some configurations of an embodiment can be replaced by a configuration of another embodiment, and a configuration of an embodiment can be added to a configuration of another embodiment. In addition, some configurations of each embodiment can be be added, deleted, replaced, integrated, or distributed. In addition, the configurations and processes shown in the embodiments can be appropriately distributed, integrated, or replaced based on processing efficiency or implementation efficiency.

What is claimed is:

1. A management computer for managing a system that makes an inference using a training model, the computer comprising a processor for performing a process in cooperation with a memory,
wherein the processor executes:
a generation process for generating an accuracy improvement prediction model for predicting the accuracy of a retrained model when retraining is executed using retraining data including new collected data collected from the system after the start of the operation of the system based on a correlation between the Feature of training data used for training of the training model and the accuracy of the training model;
a prediction process for predicting the accuracy of the retrained model from the accuracy improvement prediction model and the Feature of the retraining data; and
a determination process for determining whether or not the execution of the retraining is necessary based on the predicted accuracy of the retrained model.

2. The management computer according to claim 1,
wherein the processor executes a process for displaying the determination result of whether or not the execution of the retraining is necessary on a display unit.

3. The management computer according to claim 2,
wherein the processor executes a process for displaying one or more of a time-series graph of the accuracy of an in-operation model that is a training model in operation in the system, a correlation graph of the Feature of the training data and the accuracy of the training model, a time-series graph of the number of cumulative data of the new collected data, and the value of the predicted accuracy of the retrained model on the display unit.

4. The management computer according to claim 1,
wherein the processor determines in the determination process whether or not the execution of the retraining is necessary based on the predicted accuracy of the retrained model and the accuracy of the training model in operation in the system.

5. The management computer according to claim 1,
wherein the processor executes a process for, when it is determined in the determination process that the retraining cannot be executed, predicting the execution time period of the retraining based on the prediction of the accuracy of the retrained model after the determination.

6. The management computer according to claim 1,
wherein the processor executes a process for, when it is determined in the determination process that the retraining cannot be executed, predicting the execution time period of the retraining based on the accuracy of the retrained model after the determination and the prediction of the accuracy of the training model in operation in the system.

7. The management computer according to claim 1,
wherein the processor executes a process for, when it is determined in the determination process that the retraining cannot be executed, allowing the display unit to display a display recommending to expand the retraining data.

8. The management computer according to claim 1,
wherein the processor generates, in the generation process, the accuracy improvement prediction model based on a correlation between the Feature of a data set and the accuracy of the training model, the Feature of a data set including the training data and data collected from another system making an inference by using the training model.

9. The management computer according to claim 1,
wherein the processor executes a process for updating the accuracy improvement prediction model when the training model in operation is updated in the system.

10. The management computer according to claim 1,
wherein the processor generates the accuracy improvement prediction model for each feature of a system making an inference by using the training model in the generation process, executes a selection process for selecting an accuracy improvement prediction model used in the prediction process from those generated for each feature based on the feature of the system, and predicts the accuracy of the retrained model from the accuracy improvement prediction model selected in the selection process and the Feature of the retraining data In the prediction process.

11. The management computer according to claim 1,
wherein the Feature of the training data is the number of data of the training data.

12. The management computer according to claim 1,
wherein the Feature of the training data is a data collection period of the training data.

13. The management computer according to claim 1,
wherein the processor generates the accuracy improvement prediction model for each group based on a correlation between the Feature of data in each group obtained by grouping the training data and the accuracy of each training model when the training is performed by using the training data in each group in the generation process, and predicts, when a new group different from existing groups obtained by grouping the training data is detected in the respective groups obtained by grouping the retraining data, the accuracy of the retrained model based on the accuracy improvement prediction model for each group and either or both of the Feature of data in the new group and the Feature of data in the existing groups in the prediction process.

14. The management computer according to claim 1,
wherein the processor determines whether or not the execution of the retraining is necessary based on the predicted accuracy of the retrained model in the determination process when the probability distribution of the Feature of the training data and the probability distribution of the Feature of the retraining data can be regarded as the same based on a predetermined statistical index.

15. The management computer according to claim 1,
wherein the processor generates the accuracy improvement prediction model based on a correlation between a Feature indicating a relationship between the predetermined statistical indices of the probability distribution of the Feature of the training data and the probability distribution of the Feature of the retraining data and the accuracy of the training model in the generation process.

16. The management computer according to claim 1,
wherein the Feature of the training data is an influence function of each training data, and
wherein the processor generates the accuracy improvement prediction model based on a correlation between the influence function of the training model and the change amount of the accuracy of the training model according to the influence function in the generation process, predicts the change amount of the accuracy of the retrained model from the accuracy improvement prediction model and the influence function of the retraining data in the prediction process, and determines whether or not the execution of the retraining is necessary based on the predicted change amount of the accuracy of the retrained model in the determination process.

17. The management computer according to claim 1,
wherein the processor groups the training data, and generates the accuracy improvement prediction model based on a correlation between the Feature of the training data obtained by sampling only the same number of data from the respective grouped groups and the accuracy of the training model when the training is performed by using the training data in the generation process.

18. The management computer according to claim 1,
wherein the processor samples the Feature of the training data by using a Bayesian optimization method.

19. A management program that allows a computer to function as a management computer for managing a system making an inference using a training model, the program allows the computer to execute:
a generation process for generating an accuracy improvement prediction model for predicting the accuracy of a retrained model when retraining is executed using retraining data including new collected data collected from the system after the start of the operation of the system based on a correlation between the Feature of training data used for training of the training model and the accuracy of the training model;
a prediction process for predicting the accuracy of the retrained model from the accuracy improvement prediction model and the Feature of the retraining data; and
a determination process for determining whether or not the execution of the retraining is necessary based on the predicted accuracy of the retrained model.

20. A management method executed by a management computer that manages a system making an inference using a training model,
wherein the management computer executes:
a generation process for generating an accuracy improvement prediction model for predicting the accuracy of a retrained model when retraining is executed using retraining data including new collected data collected from the system after the start of the operation of the system based on a correlation between the Feature of training data used for training of the training model and the accuracy of the training model;
a prediction process for predicting the accuracy of the retrained model from the accuracy improvement prediction model and the Feature of the retraining data; and
a determination process for determining whether or not the execution of the retraining is necessary based on the predicted accuracy of the retrained model.
